(19) United States
(12) Patent Application Publication
(10) Pub. No.: US 2024/0166367 A1
(43) Pub. Date: May 23, 2024

(54) TOWBAR FOR AIRCRAFT

(71) Applicant: ACE CONTROLS INC., Farmington Hills, MI (US)

(72) Inventors: Christopher M. Niemiec, Livonia, MI (US); David Wiiliam Rowland, Livonia, MI (US); Wyatt Joseph Kastl, Royal Oak, MI (US)

(73) Assignee: ACE CONTROLS INC., Farmington Hills, MI (US)

(21) Appl. No.: 18/500,410

(22) Filed: Nov. 2, 2023

Related U.S. Application Data
(60) Provisional application No. 63/426,892, filed on Nov. 21, 2022.

(51) Int. Cl. B64F 1/22

(52) U.S. Cl. CPC B64F 1/224

(57) ABSTRACT

A shock absorber for towbars provides damping forces that reduce forces when stopping and starting during towing operations of aircraft.

### CROSS-REFERENCE TO RELATED APPLICATION

This application claims the benefit under 35 U.S.C. § 119(e) to U.S. Provisional Patent Application No. 63/426,892, filed Nov. 21, 2022, entitled “TOWBAR FOR AIRCRAFT,” which is incorporated herein by reference in its entirety.

### BACKGROUND OF THE INVENTION

Various towbars have been developed to tow aircraft. Towbars are typically configured to connect a tow vehicle to the landing gear of an aircraft whereby the tow vehicle can tow the aircraft when the aircraft is on the ground.

### BRIEF SUMMARY OF THE INVENTION

A towbar for towing an aircraft includes a first structure having a first connector that is adapted to be connected to a selected one of a landing gear of an aircraft or a tow vehicle. The towbar further includes a second structure having a second connector that is adapted to be connected to the other of a landing gear of an aircraft in a tow vehicle. A shock assembly operably interconnects the first and second structures and provides damping forces that resist movement of the first and second structures towards one another and away from one another. The shock assembly includes a first spring biasing the first and second structures away from each other, and a second spring biasing the first and second structures towards each other, whereby the first and second structures are biased to an initial position relative to each other. The shock assembly further includes a damper comprising a first fluid chamber and a second fluid chamber that is in fluid communication with a first fluid chamber through a plurality of spaced-apart orifices that restrict flow of fluid between the first fluid chamber and the second fluid chamber. The damper includes a piston rod extending through at least a portion of the first fluid chamber and a piston in the first fluid chamber that moves with the piston rod. The piston sealingly engages an inner surface of the first fluid chamber whereby the first fluid chamber is divided into first and second portions by the piston. Movement of the piston in the first fluid chamber in a first direction causes fluid in the first portion of the first fluid chamber to be pressurized and flow out of the first portion of the first fluid chamber through at least one orifice and into the second fluid chamber, and then through at least one orifice into the second portion of the first fluid chamber, whereby the fluid acts on the piston to resist movement of the piston rod in the first direction. Movement of the piston in the first fluid chamber in a second direction that is opposite to the first direction causes fluid in the second portion of the first fluid chamber to be pressurized and flow out of the second portion of the first fluid chamber through at least one orifice into the second fluid chamber and then through at least one orifice into the first portion of the first fluid chamber, whereby the fluid acts on the piston to resist movement of the piston rod in the second direction. A number of orifices fluidly interconnecting the first portion of the first fluid chamber and the second fluid chamber changes as the piston moves in the first direction, and also changes as the piston moves in the second direction. A number of orifices fluidly interconnecting the second portion of the first fluid chamber and the second fluid chamber changes as the piston moves in the first direction, and also changes as the piston moves in the second direction, such that a restriction on the flow of fluid through the orifices varies as a function of a position of the piston in the first fluid chamber. The piston rod is connected to the first structure, and the first fluid chamber and the second fluid chamber are part of the second structure, such that movement of the first structure relative to the second structure moves the piston in the first fluid chamber, and the piston thereby causes a damping force tending to resist movement of the first structure relative to the second structure. The damping force varies as a function of a position of the first structure relative to the second structure, and as a function of a velocity of the first structure relative to the second structure.

The second structure optionally includes a guide structure that slidably engages a bearing of the first structure to form a linear bearing that operably interconnects the first structure and the second structure.

The guide structure optionally comprises a tube, and the bearing optionally comprises a bushing having an inner surface that slidably engages an outer surface of the tube.

The tube optionally comprises an outer tube, and an inner tube may be disposed inside the outer tube whereby the first fluid chamber comprises an interior space of the inner tube, and the second fluid chamber comprises a space between the inner tube and the outer tube.

The tow bar may optionally include first and second end plugs engaging opposite ends of the inner and outer tubes. The piston rod may extend through openings in the first and second end plugs, whereby the piston rod moves linearly relative to the first and second end plugs.

The first spring optionally comprises a compression spring having a first end that engages the first structure, and a second end that engages the second structure. The second spring optionally comprises a compression spring having a first end that engages the second structure, and a second end that engages the piston rod.

The first structure optionally comprises a first tubular end portion, and the second structure optionally comprises a second tubular end portion. A first end of the piston rod may be disposed inside the first tubular end portion, and a second end of the piston rod may be disposed inside the second tubular end portion.

The second end of the first spring optionally engages the first end plug, and the first end of the second spring optionally engages the second end plug.

The piston optionally comprises 1) a piston head, 2) a piston ring that sealingly engages an inner surface of the inner tube, and 3) a piston head bearing that slidably engages the inner surface of the inner tube.

The plurality of spaced apart orifices are optionally formed in a sidewall of the inner tube. The orifices are optionally evenly spaced apart from one another. Optionally, all of the orifices are the same size. The orifices are optionally arranged in a line parallel to an axis of the inner tube.

Movement of the first structure relative to the second structure may define a stroke, and the damping force as a function of stroke distance may form a sawtooth pattern comprising a series of spaced apart peaks and minimums due to the changes in restrictions of fluid flow through the orifices.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an isometric view of a towbar including a shock absorber according to an aspect of the present disclosure;

FIG. 2 is an isometric view of a shock absorber according to an aspect of the present disclosure;

FIG. 3 is a partially fragmentary view of a portion of the towbar of FIG. 1;

FIG. 4 is a cross sectional view of the towbar of FIG. 3 taken along the line IV-IV;

FIG. 5 is a fragmentary enlarged view of a portion of the towbar of FIG. 1;

FIG. 6 is a graph showing force as a function of stroke length for different loading conditions of the shock absorber and towbar of FIG. 1;

FIG. 7 is a graph showing force as a function of time length for different loading conditions of the shock absorber and towbar of FIG. 1; and

FIG. 8 is a graph showing velocity as a function of stroke for different loading conditions of the shock absorber and towbar of FIG. 1.

### DETAILED DESCRIPTION

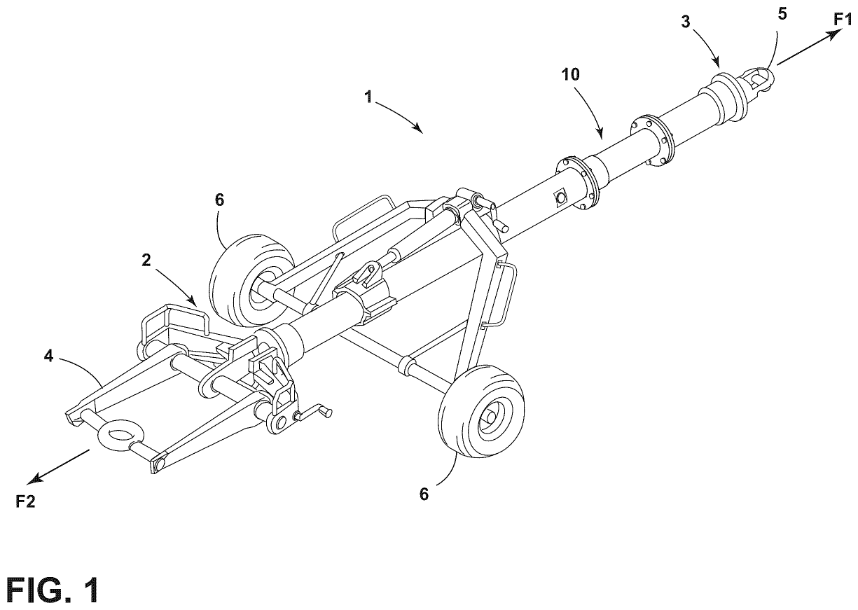

For purposes of description herein the terms “upper,” “lower,” “right,” “left,” “rear,” “front,” “vertical,” “horizontal,” and derivatives thereof shall relate to the disclosure as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1 a towbar 1 for towing aircraft includes first and second structures 2 and 3. The first structure 2 may include a connector 4 that is adapted to be connected to landing gear of an aircraft, and second structure 3 may include a connector 5 that is configured to be connected to a tow vehicle. Towbar 1 may include wheels 6 to facilitate movement of the towbar 1 when it is not connected to an aircraft. It will be understood that the connectors 4 and 5, and wheels 6 may be substantially similar to the corresponding components of known towbars, and may have virtually any suitable configuration as required for a particular application. In use, forces may be applied to towbar 1 as the tow vehicle moves the aircraft. The forces may comprise tension forces acting in the directions of the arrows F1 and F2, or compressive forces acting in directions opposite arrows F1 and F2.

The towbar 1 further includes a shock assembly 10 operably interconnecting the first and second structures 2 and 3, respectively, and providing damping forces that resist movement of the first and second structures 2 and 3, respectively, towards one another and away from one another.

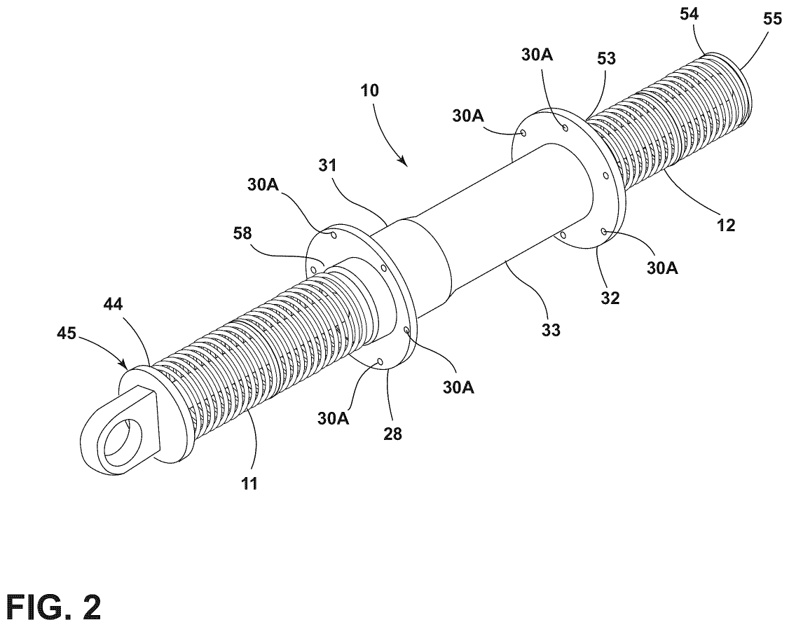

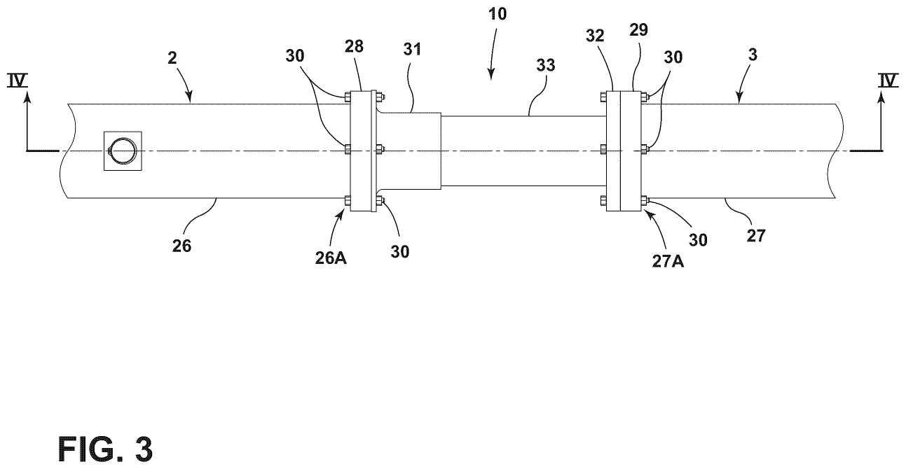

With further reference to FIGS. 2-4, the shock assembly 10 includes a first spring 11 biasing the first and second structures 2 and 3, respectively, away from each other. The shock assembly 10 also includes a second spring 12 biasing the first and second structures 2 and 3 towards each other, whereby the first and second structures 2 and 3 are biased to an initial (starting) position relative to each other.

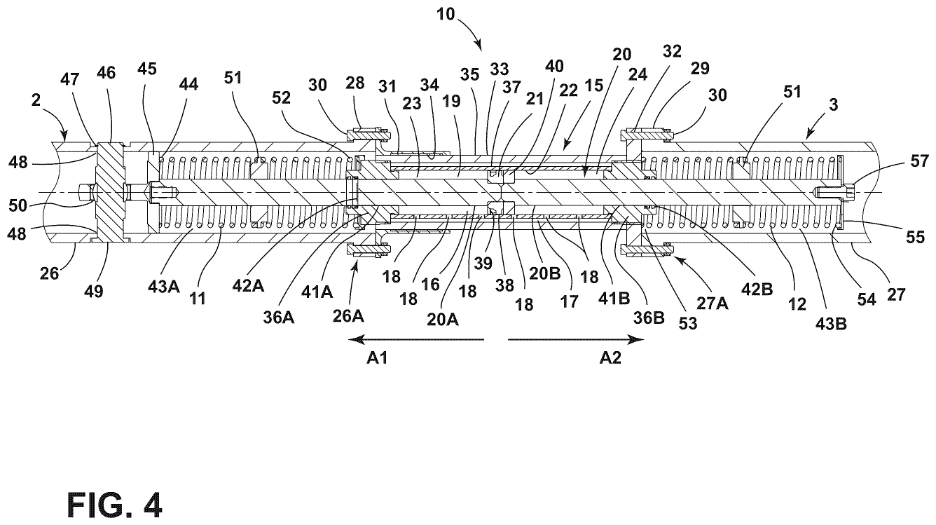

Shock assembly 10 further includes a damper 15 (FIG. 4) comprising a first fluid chamber 16 and a second fluid chamber 17 that is in fluid communication with the first fluid chamber through a plurality of spaced apart orifices 18 that restrict flow of fluid such as liquid 19 (e.g. oil) between the first fluid chamber 16 and the second fluid chamber 17. The damper 15 includes a piston rod 20 extending through at least a portion of the first fluid chamber 16, and a piston 21 in the first fluid chamber 16 that moves with the piston rod 20. The piston 21 sealingly engages an inner surface 22 of the first fluid chamber 16 whereby the first fluid chamber 16 is divided into first and second portions 23 and 24, respectively, by the piston 21 such that movement of the piston 21 in the first fluid chamber 16 in a first direction A1 causes fluid 19 in the first portion 23 of the first fluid chamber 16 to be pressurized and flow out of the first portion 23 of the first fluid chamber 16 through at least one orifice 18 into the second fluid chamber 17. The fluid 19 then flows through at least one orifice 18 into the second portion 23 of the first fluid chamber 16. The fluid 19 thereby acts on the piston 21 to resist movement of the piston rod 20 in the first direction A1. Movement of the piston 21 in the first fluid chamber 16 in a direction A2 that is opposite to the first direction A1 causes fluid 19 in the second portion 24 of the first fluid chamber 16 to be pressurized and flow out of the second portion 24 of the first fluid chamber 16 through at least one orifice 18 into the second fluid chamber 17, and then through at least one orifice 18 into the first portion 23 of the first fluid chamber 16, whereby the fluid 19 acts on the piston 21 to resist movement of the piston rod 20 in the second direction A2.

A number of orifices 18 fluidly interconnecting the first portion 23 of the first fluid chamber 16 and the second fluid chamber 17 changes as the piston 21 moves in the first direction A1, and also changes as the piston 21 moves in the second direction A2. A number of orifices 18 fluidly interconnecting the second portion 24 of the first fluid chamber 16 and the second fluid chamber 17 also changes as the piston 21 moves in the first direction A1, and also changes as the piston 21 moves in the second direction A2. Thus, a restriction on the flow of fluid 19 through the orifices 18 varies as a function of a position of the piston 21 in the first fluid chamber 16.

In general, as the piston 21 moves away from the center or rest position, the fluid 19 flows through a reduced number of orifices 18 on a first side of piston 21, and an increased number of orifices 18 on a second side of piston 21. If the orifices 18 all have the same size, the flow of fluid 19 through the reduced number of orifices 18 is more restricted than the flow through the increased number of orifices. Thus, as piston 21 moves further from the center or neutral position, the number of orifices through which fluid 19 can flow on the first side is further reduced, thereby increasing the flow restriction and damping force as the piston 21 moves further from the center (neutral) position.

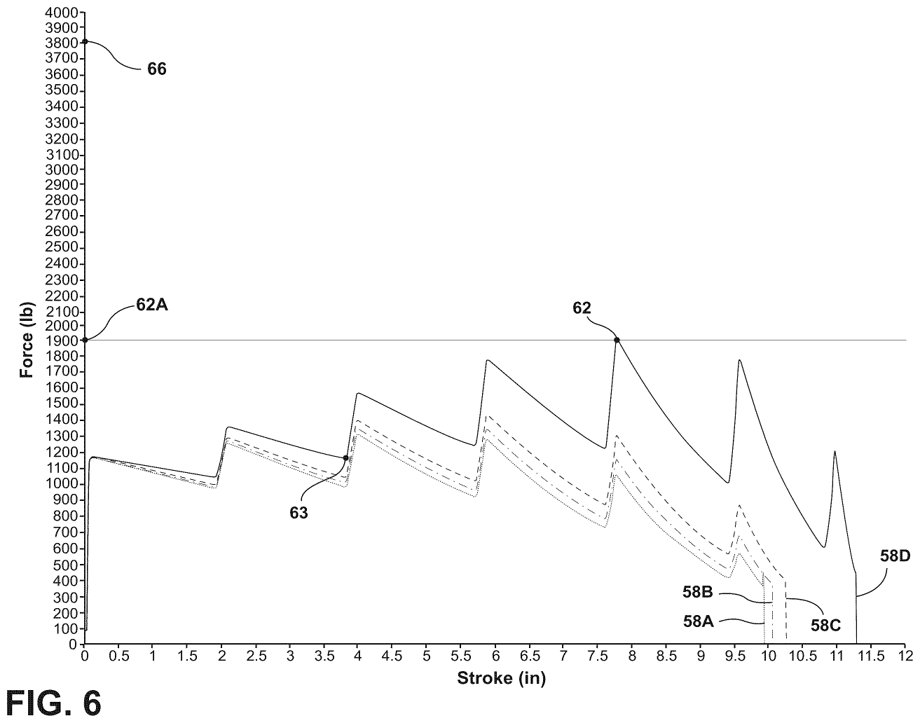

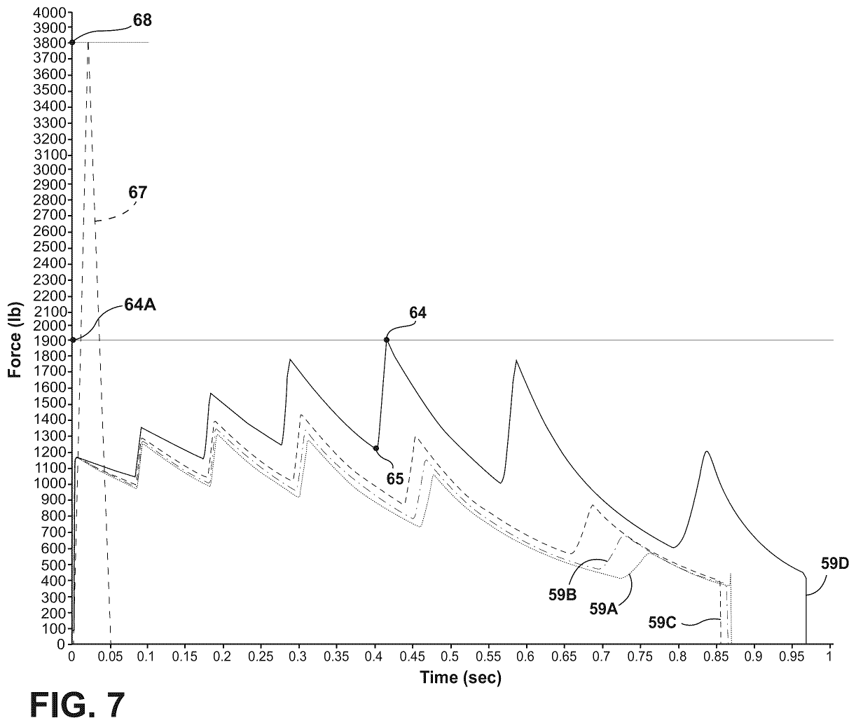

The piston rod 20 is connected to the first structure 2, and the first fluid chamber 16 and the second fluid chamber 17 are part of the second structure 3, such that movement of the first structure 2 relative to the second structure 3 moves the piston 21 in the first fluid chamber 16, and the piston 21 thereby causes a damping force tending to resist movement of the first structure 2 relative to the second structure 3. As discussed above, the damping force varies as a function of a position of the first structure 2 relative to the second structure 3. It will be understood that the damping force also varies as a function of a velocity of the first structure 2 relative to the second structure 3. Thus, when the piston 21 is positioned between orifices 18, the damping force may be proportional or approximately proportional to the velocity (e.g. Fd=cv, where Fd is the damping force, c is the damping coefficient, and v is the velocity of the piston 21 relative to the second structure 3). However, as piston ring 39 of piston 21 moves across an orifice 18, the damping coefficient changes due to the increasing or decreasing number of orifices through which liquid 19 can flow. This may result in a “sawtooth” damping force as discussed in more detail below in connection with FIGS. 6-7.

Referring again to FIGS. 2-4, first structure 2 may comprise a tube 26, and second structure 3 may comprise a tube 27. A flange 28 may be formed at an end 26A of tube 26, and a flange 29 may be formed at end 27A of tube 27. Bushing housing 31 may be secured to flange 28 of tube 26 by bolts 30 and a mounting flange 32 may be secured to flange 29 of tube 27 by bolts 30. It will be understood that bolts 30 may pass through openings 30A in flanges 28 and 32, and through corresponding openings in bushing housing 31 and mounting flange 32. A bushing 34 is supported by bushing housing 31. The bushing 34 slidably engages an outer surface 35 of an outer tube 33. An inner tube 37 is disposed inside of outer tube 33. Opposite ends of outer tube 33 and inner tube 37 engage first and second end plugs 36A and 36B, respectively, whereby the inner tube 37 is supported in a substantially coaxial position relative to outer tube 33. The first fluid chamber 16 is formed inside inner tube 37, and the second fluid chamber 17 is formed by the space between inner tube 37 and outer tube 33. The outer tube 33, inner tube 37, and end plugs 36A and 36B are joined to the second structure 3 and move with the second structure 3. Specifically, end plug 36B may be fixed to mounting flange 32.

Referring again to FIG. 4, piston rod 20 may comprise a first part 20A that is secured to a second part 20B at piston 21. Alternatively, piston rod 20 may comprise a one-piece member. Piston 21 may include a piston head 38 and a piston ring 39 that is secured to the piston head 38. The piston ring 39 slidably engages inner surface 22 of inner tube 37 to thereby form a seal that divides the first fluid chamber 16 into first portion 23 and second portion 24. The piston 21 may further include a piston head bearing 40 that slidably engages inner surface 22 of inner tube 37. Piston head bearing 40 causes the piston rod 20 to remain centered in inner tube 37 as the piston rod 20 moves in the directions A1 and A2. The piston rod 20 also extends through openings 41A and 41B in end plugs 36A and 36B, respectively whereby the piston rod 20 is slidably supported by the end plugs 36A and 36B. Rod seals or wipers 42A and 42B may be secured to end plugs 36A and 36B, respectively to seal the first fluid chamber 16 such that liquid 19 cannot flow into interior spaces 43A and 43B of tubes 26 and 27, respectively.

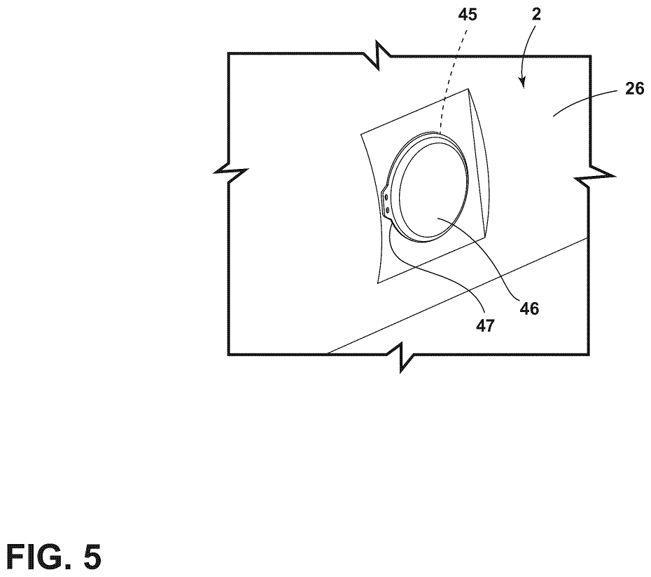

Referring again to FIG. 4, first spring 11 may comprise a compression spring having a first end 11 that engages a rod clevis 45. The rod clevis 45 is secured to the tube 26 of first structure 2 by a clevis pin 46 that extends through openings 48 in tube 26. Clevis pin 46 includes a head 49 at a first end, and a ring 47 engages the other end of clevis pin 46 (see also FIG. 5) to thereby retain the clevis pin 46 to the tube 26. A ball joint 50 connects rod clevis 45 to clevis pin 46. Spring retainer 51 is utilized to retain a center portion of springs 11 and 12.

A second end 52 of first spring 11 engages end plug 36A. As discussed above, end plug 36A is secured to second structure 3, and moves with second structure 3. Thus, the first spring 11 generates a force tending to push (bias) the first end structures 2 and 3, respectively away from each other.

Referring again to FIG. 4, second spring 12 has a first end 53 that engages the end plug 36B and/or mounting flange 32 of second structure 3. Second spring 12 has a second end 54 that engages a spring retainer 55 that is secured to piston rod 20 by a threaded fastener 56. The second spring 12 thereby generates a force tending to pull (bias) the first and second structures 2 and 3, respectively, towards one another.

Referring again to FIG. 4, as discussed above, first fluid chamber 16 and second fluid chamber 17 are fluidly interconnected by a plurality of orifices 18 extending through inner tube 37. Because the total volume of the first and second fluid chambers 16 and 17 is substantially fixed, movement of piston 21 in first fluid chamber 16 causes changes in the volumes of the first portion 23 and second portion 24 of first fluid chamber 16. These changes in volume are equal and opposite, and the liquid 19 is preferably oil or other liquid that is incompressible. As discussed above, the piston 21 moves in direction A1, the number of orifices 18 that are fluidly connected to first portion 23 of first fluid chamber 16 is reduced, such that the total area available for liquid 19 to flow through orifices 18 into second fluid chamber 17 is reduced. This reduction in flow area through orifices 18 changes the flow restriction between first and second portions 23 and 24, respectively, of first fluid chamber 16. Similarly, movement of piston 21 in the direction A2 reduces the number of orifices 18 that are fluidly connected to the second portion 24 of first fluid chamber 16, thereby reducing the area for the fluid to flow through as it exits the second portion 24 of first fluid chamber 16. In general, the orifices 18 may all have the same cross sectional area, and orifices 18 may be spaced evenly in a linear relationship to one another along a line. However, the orifices 18 may have different sizes and uneven spacing. Also, the orifices 18 do not necessarily need to be in a straight line. The sizes and positions of the orifices 18 may be adjusted as required for a particular application to provide a desired damping force that resists movement of first and second structures 2 and 3, respectively, relative to one another.

In general, the damping force resulting from flow of liquid 19 increases as a velocity of first structure 2 relative to second structure 3 increases. However, as discussed above, because the area of the orifices 18 through which liquid 19 flows varies depending on the position of piston 21, the damping force as a function of velocity may change as the position of the piston 21 changes due to changes in the damping coefficient.

FIGS. 6-8 show computer-simulated results for a shock assembly 10 as described above in connection with FIGS. 1-5. Although FIGS. 6-8 are based on computer simulations, these results correspond to actual shock behavior. It will be understood that the forces, stroke lengths, velocities and times of FIGS. 6-8 are examples for one exemplary shock assembly 10 when subject to exemplary forces, and the actual forces, stroke lengths, velocities, times, and other operating parameters may vary depending on the forces applied to the shock assembly 10, and the specific design of a given shock assembly 10. In general, the dimensions and configurations of the components of shock assembly 10 can be adjusted to provide a desired level of force reduction as required for a particular application.

With reference to FIG. 6, the damping forces of shock assembly 10 for different applied forces (e.g. F1 and F2, FIG. 1) are represented by the lines 58A-58D. The total force (lines 58A-58D) is the sum of damping forces of damper 15 and forces of springs 11 and 12. In general, the magnitude of the damping force includes a series of peaks 62 and valleys 63 that result from changes in the number of orifices 18 through which fluid can flow due to movement of the piston 21. In general, although the total area of the orifices 18 remains the same, the flow of the liquid 19 through the orifices 18 is limited by the portion 23 or 24 of first fluid chamber 16 (FIG. 4) having the fewest number of orifices 18 fluidly interconnecting the first fluid chamber 16 with the second fluid chamber 17. For example, if piston 21 is shifted in the direction of the arrow A1 as first and second structures 2 and 3 are pulled apart, the first portion 23 of first fluid chamber 16 may be fluidly interconnected with second fluid chamber 17 by only one or two orifices 18, whereas the second portion 24 of first fluid chamber 16 may be fluidly interconnected to second fluid chamber 17 by significantly more than one or two orifices 18. However, the reduced number of orifices 18 fluidly connecting first portion 23 of first fluid chamber 16 to second fluid chamber 17 is a greater restriction on fluid flow, and may therefore have a more significant effect on the damping force.

In a towbar without shock assembly 10, the force will typically be significantly greater (with no stroke) with a peak force 66. In the example of FIG. 6, a peak force (point 62A) in a towbar 1 including a shock assembly 10 may be about one half of the peak force 66 of a corresponding towbar that does not include a shock assembly 10. The reduction in peak force can be adjusted as required for a particular application by changing the configuration of damper 15, springs 11 and 12, etc.

With further reference to FIG. 7, when the same loads as FIG. 6 are applied and plotted to show force as a function of time, the force again varies between peaks 64 and valleys 65 for different forces as shown by the lines 59A-59D in FIG. 7. It will be understood that the forces of FIGS. 6 and 7 are the same, and the differences in the graphs are due to the fact that FIG. 6 shows force versus stroke (distance), whereas FIG. 7 shows force versus time. If a towbar does not include a shock assembly 10, the force (line 67) will typically reach a peak 68 that is much greater than a peak 64A for a towbar 1 having a shock assembly 10, and force 67 will typically have a very short duration. As discussed above in connection with FIG. 6, the peak force 64A may be about one half of peak force 68.

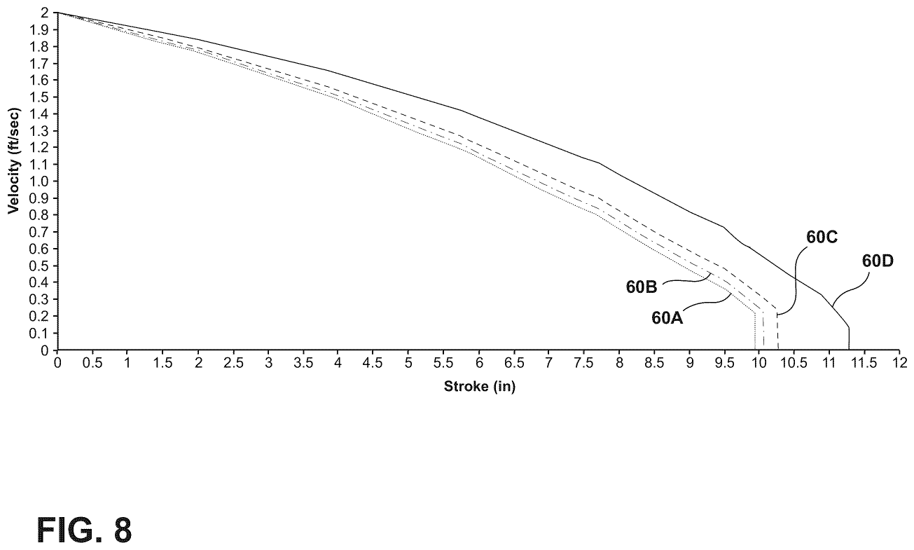

FIG. 8 is a graph showing velocity of piston 21 (first structure 2) relative to second structure 3 as a function of piston stroke distance for the same four load conditions of FIGS. 6 and 7. Thus, lines 58B, 59B, and 60B in FIGS. 6, 7, and 8, respectively, correspond to the same load. In general, the different applied forces of FIGS. 6-8 correspond to aircraft having different weights and traveling at the same initial velocity. It will be understood that the velocities of the aircraft may also vary, and the forces of shock assembly 10 may also vary accordingly. Thus, in FIG. 8, all four lines 60A-60D initially have the same velocity at a stroke of zero, but the velocities change at a different rate relative to the stroke length due to the different weights of the aircraft. The stroke (distance) of zero in FIGS. 6 and 8 generally corresponds to FIG. 4 in which the piston 21 is in a neutral or initial (center) position. As noted above, the piston 21 and piston rod 20 are biased to the neutral position corresponding to zero stroke distance in FIGS. 6 and 8. In general, movement of piston 21 in either direction A1 or A2 (FIG. 4) will result in the force variations shown in FIGS. 6-8 because the orifices 18 are evenly spaced and have equal size. However, as discussed above, the spacing and/or sizes of the orifices 18 do not necessarily need to be equal, and the forces generated during extension and retraction of shock assembly 10 may therefore be different than the examples of FIGS. 6-8. In general, a towbar that does not include a shock assembly 10 will not have a piston velocity or a piston stroke, and FIG. 8 does not therefore include a force curve for a towbar that does not have a shock assembly 10.

The shock assembly 10 of the present disclosure reduces stopping forces compared to a towbar having a solid structure interconnecting the connectors 4 and 5 (FIG. 1). The towbar 1 (FIG. 1) may be fabricated to include shock assembly 10 during initial manufacture of the towbar 1. Alternatively, a towbar that does not initially include a shock assembly 10 may be retro fitted to include shock assembly 10. For example, the towbar 1 may be cut to form separate tubes 26 and 27, and flanges 28 and 29 may be welded to the tubes to provide mounting locations for the shock assembly 10. In general, a section of the original tube can be removed to install shock assembly 10 whereby the overall length of the towbar remains the same after shock assembly 10 is installed.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

The invention claimed is:

1. A tow bar for towing an aircraft, the tow bar comprising:
a first structure having a first connector that is adapted to be connected to a selected one of a landing gear of an aircraft or a tow vehicle;
a second structure having a second connector that is adapted to be connected to the other of a landing gear of an aircraft and a tow vehicle; and
a shock assembly operably interconnecting the first and second structures and providing damping forces that resist movement of the first and second structures towards one another and when the first and second structures move away from one another, the shock assembly including:
a first spring biasing the first and second structures away from each other;
a second spring biasing the first and second structures towards each other, whereby the first and second structures are biased to an initial position relative to each other;
a damper comprising a first fluid chamber having fluid therein and a second fluid chamber, wherein the second fluid chamber is in fluid communication with the first fluid chamber through a plurality of spaced-apart orifices that restrict flow of fluid between the first fluid chamber and the second fluid chamber, the damper including a piston rod extending through at least a portion of the first fluid chamber and a piston in the first fluid chamber that moves with the piston rod, wherein the piston sealingly engages an inner surface of the first fluid chamber whereby the first fluid chamber is divided into first and second portions by the piston such that: 1) movement of the piston in the first fluid chamber in a first direction causes fluid in the first portion of the first fluid chamber to be pressurized and flow out of the first portion of the first fluid chamber through at least one orifice and into the second fluid chamber, and then through at least one orifice into the second portion of the first fluid chamber, whereby the fluid acts on the piston to resist movement of the piston rod in the first direction; and 2) movement of the piston in the first fluid chamber in a second direction that is opposite to the first direction causes fluid in the second portion of the first fluid chamber to be pressurized and flow out of the second portion of the first fluid chamber through at least one orifice into the second fluid chamber and then through at least one orifice into the first portion of the first fluid chamber, whereby the fluid acts on the piston to resist movement of the piston rod in the second direction;
and wherein a number of orifices fluidly interconnecting the first portion of the first fluid chamber and the second fluid chamber changes as the piston moves in the first direction, and also changes as the piston moves in the second direction;
and wherein a number of orifices fluidly interconnecting the second portion of the first fluid chamber and the second fluid chamber changes as the piston moves in the first direction, and also changes as the piston moves in the second direction, such that a restriction on the flow of fluid through the orifices varies as a function of a position of the piston in the first fluid chamber;
and wherein: 1) the piston rod is connected to the first structure, and 2) the first fluid chamber and the second fluid chamber are part of the second structure, such that movement of the first structure relative to the second structure moves the piston in the first fluid chamber and the piston thereby causes a damping force tending to resist movement of the first structure relative to the second structure, wherein the damping force varies as a function of a position of the first structure relative to the second structure and as a function of a velocity of the first structure relative to the second structure.

2. The towbar of claim 1, wherein:
the second structure includes a guide structure that slidably engages a bearing of the first structure to form a linear bearing operably interconnecting the first structure and the second structure.

3. The towbar of claim 2, wherein:
the guide structure comprises a tube;
the bearing comprises a bushing having an inner surface that slidably engages an outer surface of the tube.

4. The towbar of claim 3, wherein:
the tube comprises an outer tube; and including:
an inner tube disposed inside the outer tube whereby the first fluid chamber comprises an interior space of the inner tube, and the second fluid chamber comprises a space between the inner tube and the outer tube.

5. The towbar of claim 4, including:
first and second plugs engaging opposite ends of the inner and outer tubes;
and wherein the piston rod extends through openings in the first and second end plugs whereby the piston rod moves linearly relative to the first and second end plugs.

6. The towbar of claim 5, wherein:
the first spring comprises a compression spring having a first end that engages the first structure, and a second end that engages the second structure;
the second spring comprises a compression spring having a first end that engages the second structure, and a second end that engages the piston rod.

7. The towbar of claim 6, wherein:
the first structure comprises a first tubular end portion;
the second structure comprises a second tubular end portion;
a first end of the piston rod is disposed inside the first tubular end portion, and a second end of the piston rod is disposed inside the second tubular end portion.

8. The towbar of claim 7, wherein:
the second end of the first spring engages the first end plug;
the first end of the second spring engages the second end plug.

9. The towbar of claim 8, wherein:
the piston comprises: 1) a piston head, 2) a piston ring that sealing engages an inner surface of the inner tube, and 3) a piston head bearing that slidably engages the inner surface of the inner tube.

10. The towbar of claim 4, wherein:
the plurality of spaced apart orifices are formed in a sidewall of the inner tube.

11. The towbar of claim 10, wherein:
the orifices are evenly spaced apart from one another, and
all of the orifices are the same size.

12. The towbar of claim 10, wherein:
the orifices are arranged in a line parallel to an axis of the inner tube.

13. The towbar of claim 1, wherein:
movement of the first structure relative to the second structure defines a stroke;
a magnitude of the damping force as a function of stroke distance forms a sawtooth pattern comprising a series of spaced apart peaks and minimums due to the changes in restrictions of fluid flow through the orifices.

14. A tow bar for towing an aircraft, the tow bar comprising:
a first structure having a first connector that is adapted to be connected to a selected one of a landing gear of an aircraft or a tow vehicle;
a second structure having a second connector that is adapted to be connected to the other of a landing gear of an aircraft and a tow vehicle; and
a shock assembly operably interconnecting the first and second structures and providing damping forces that resist movement of the first and second structures towards one another and when the first and second structures move away from one another, the shock assembly including:
a first resilient member biasing the first and second structures away from each other;
a second resilient member biasing the first and second structures towards each other, whereby the first and second structures are biased to an initial position relative to each other;
a damper comprising a first fluid chamber having fluid therein and a second fluid chamber, wherein the second fluid chamber is in fluid communication with the first fluid chamber through a plurality of spaced-apart orifices that restrict flow of fluid between the first fluid chamber and the second fluid chamber, the damper including a piston that sealingly engages an inner surface of the first fluid chamber such that: 1) movement of the piston in a first direction causes fluid in a first portion of the first fluid chamber to be pressurized and flow out of the first portion of the first fluid chamber through at least one orifice and into the second fluid chamber, and then through at least one orifice into a second portion of the first fluid chamber, whereby the fluid acts on the piston to resist movement of the piston rod in the first direction; and 2) movement of the piston in a second direction causes fluid in the second portion of the first fluid chamber to be pressurized and flow out of the second portion of the first fluid chamber through at least one orifice into the second fluid chamber and then through at least one orifice into the first portion of the first fluid chamber, whereby the fluid acts on the piston to resist movement of the piston rod in the second direction;
and wherein: 1) the piston rod is connected to the first structure, and 2) the first fluid chamber and the second fluid chamber are part of the second structure, such that movement of the first structure relative to the second structure moves the piston in the first fluid chamber and the piston thereby causes a damping force tending to resist movement of the first structure relative to the second structure, wherein the damping force varies as a function of a position of the first structure relative to the second structure and as a function of a velocity of the first structure relative to the second structure; wherein
movement of the first structure relative to the second structure defines a stroke;
a magnitude of the damping force as a function of stroke distance forms a sawtooth pattern comprising a series of spaced apart peaks and minimums due to the changes in restrictions of fluid flow through the orifices.

15. The towbar of claim 14, wherein:
a number of orifices fluidly interconnecting the first portion of the first fluid chamber and the second fluid chamber changes as the piston moves in the first direction, and also changes as the piston moves in the second direction;
a number of orifices fluidly interconnecting the second portion of the first fluid chamber and the second fluid chamber changes as the piston moves in the first direction, and also changes as the piston moves in the second direction, such that a restriction on the flow of fluid through the orifices varies as a function of a position of the piston in the first fluid chamber.

16. The towbar of claim 14, wherein:
the second structure includes a guide structure that slidably engages a bearing of the first structure to form a linear bearing operably interconnecting the first structure and the second structure.

17. The towbar of claim 16, wherein:
the guide structure comprises an outer tube;
the bearing comprises a bushing having an inner surface that slidably engages an outer surface of the tube; and including:
an inner tube disposed inside the outer tube whereby the first fluid chamber comprises an interior space of the inner tube, and the second fluid chamber comprises a space between the inner tube and the outer tube.

18. The towbar of claim 17, wherein:
the first resilient member comprises a compression spring having a first end that engages the first structure, and a second end that engages the second structure;
the second resilient member comprises a compression spring having a first end that engages the second structure, and a second end that engages the piston rod.

19. The towbar of claim 18, wherein:
the piston comprises: 1) a piston head, 2) a piston ring that sealing engages an inner surface of the inner tube, and 3) a piston head bearing that slidably engages the inner surface of the inner tube.

20. A tow bar for towing an aircraft, the tow bar comprising:
a first structure having a first connector that is adapted to be connected to a selected one of a landing gear of an aircraft or a tow vehicle;
a second structure having a second connector that is adapted to be connected to the other of a landing gear of an aircraft and a tow vehicle; and
a shock assembly operably interconnecting the first and second structures and providing damping forces that resist movement of the first and second structures towards one another and when the first and second structures move away from one another, the shock assembly including a damper comprising a first fluid chamber and a second fluid chamber that is in fluid communication with the first fluid chamber through a plurality of spaced-apart orifices; and wherein:
movement of the first structure relative to the second structure defines a stroke;
the damper is configured such that a magnitude of the damping force as a function of stroke distance forms a pattern comprising a series of spaced apart peaks and minimums due to changes in restriction of fluid flow through the orifices fluidly interconnecting the first and second fluid chambers of the damper.
